(19) United States
(12) Patent Application Publication
(10) Pub. No.: US 2005/0235781 A1
(43) Pub. Date: Oct. 27, 2005

(54) Socket and ratchet wrench

(76) Inventor: Daniel Lee, Tali City (TW)

Correspondence Address: CHARLES E. BAXLEY, ESQ., 90 JOHN STREET, THIRD FLOOR, NEW YORK, NY, 10038, US

(21) Appl. No.: 11/170,001

(22) Filed: Jun. 28, 2005

Related U.S. Application Data
(63) Continuation-in-part of application No. 10/671,757, filed on Sep. 26, 2003.

(51) Int. Cl. B25B 13/46

(52) U.S. Cl. 81/60

(57) ABSTRACT

A socket and ratchet wrench comprises: an annular-toothed block rotatably received in a wrench body, and a socket. The annular-toothed block has a through engaging hole defined with multiple ribs each connected by a negative arc surface, the respective ribs includes a flat first engaging surface and two cambered second engaging surfaces connected the first engaging surface by an arc surface. At a first end of the socket are formed multiple grooves for mating with the respective ribs of the annular-toothed block, and at the second end are provided multiple planes for engaging with the second engaging surfaces of the respective ribs.

This application is a continuation of part of U.S. patent application Ser. No. 10/671,757 filed on Sep. 26, 2003.

### BACKGROUND OF THE INVENTION

1. Field of the Invention

The present invention relates to a socket and ratchet wrench, and more particularly to a ratchet wrench that is not only applicable to different structured sockets.

2. Description of the Prior Art

A ratchet wrench and a socket of prior art are shown in FIG. 1, the ratchet wrench includes a head portion 11, a body 10 and a unidirectionally rotatable ratchet 12 received in the head portion 11. At the center of the ratchet 12 is formed a through engaging hole 13 having a plurality of positive arc ribs 131 formed on the inner periphery thereof. The socket 20 has an engaging hole 21 for engaging with the fasteners to be locked (such as screw and nut), on the outer periphery of the socket 20 are formed a plurality of arc grooves 22 for mating with the respective positive arc ribs 131 of the ratchet 12. The wrench body 10 serves to rotate the socket 20 during operation. However, this conventional ratchet wrench and socket still have some disadvantages that need to be improved:

First, the respective ribs 131 on the ratchet 12 have a positive arc cross section, and the grooves 22 of the socket 20 also should be arc-shaped in cross section in order to mate with the ribs 131. Therefore, the ratchet wrench with positive arc ribs 131 is suitable for use on the socket with arc grooves only.

Second, the head of the fastener 30 usually has a polygonal shape (such as hexagonal or octagonal shape), the ratchet wrench will use the ribs 131 to push against the periphery of the fastener 30 when screwing or unscrewing the fastener 30. Plus the contact between the ribs 131 and the periphery of the fastener 30 is line contact, therefore, slippage will likely be caused between the ratchet 12 of the fastener 30.

The present invention has arisen to mitigate and/or obviate the afore-described disadvantages of the conventional ratchet wrench.

### SUMMARY OF THE INVENTION

The primary object of the present invention is to provide a socket and ratchet wrench that is applicable to different shaped sockets.

Another object of the present invention is to provide a socket and ratchet wrench capable of rotating polygonal fasteners.

The present invention will become more obvious from the following description when taken in connection with the accompanying drawings, which shows, for purpose of illustrations only, the preferred embodiment in accordance with the present invention.

### BRIEF DESCRIPTION OF THE DRAWINGS

FIG. 1 is plan view of a conventional socket and ratchet wrench;

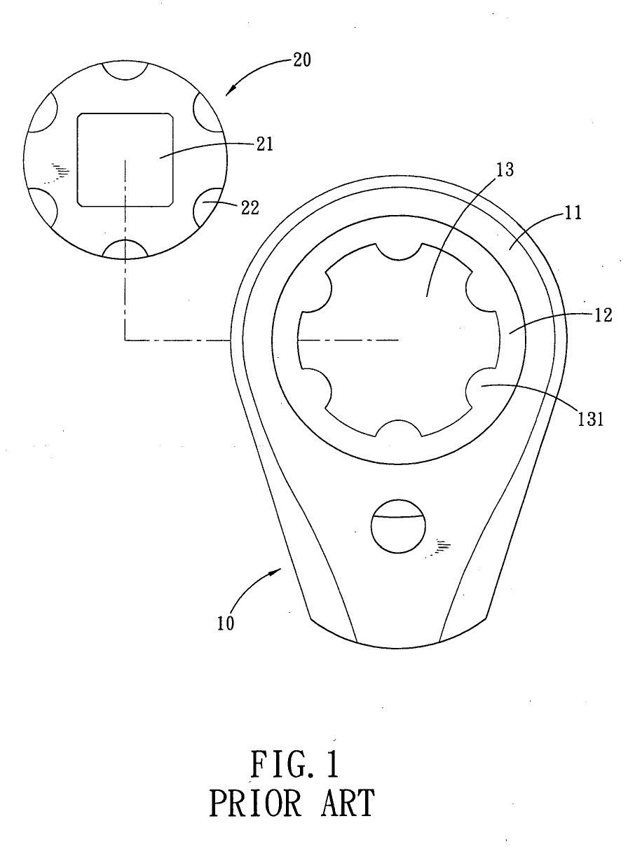

FIG. 2 is another plan view of a conventional socket and ratchet wrench;

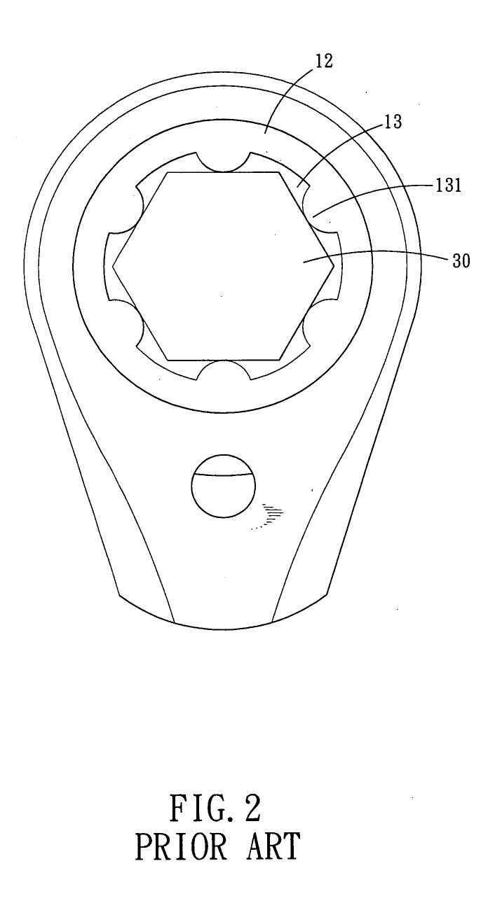

FIG. 3 is an exploded view of a socket and ratchet wrench of the present invention;

FIG. 4 is a perspective assembly view of the socket and ratchet wrench of the present invention;

FIG. 5 is a top view of the socket and ratchet wrench of the present invention, wherein the ratchet engages with a first end of the socket;

FIG. 6 is a partial amplified view of FIG. 5;

FIG. 7 is a top view of the socket and ratchet wrench of the present invention, wherein the ratchet engages with a second end of the socket;

FIG. 8 is a partial amplified view of FIG. 7.

### DETAILED DESCRIPTION OF THE PREFERRED EMBODIMENT

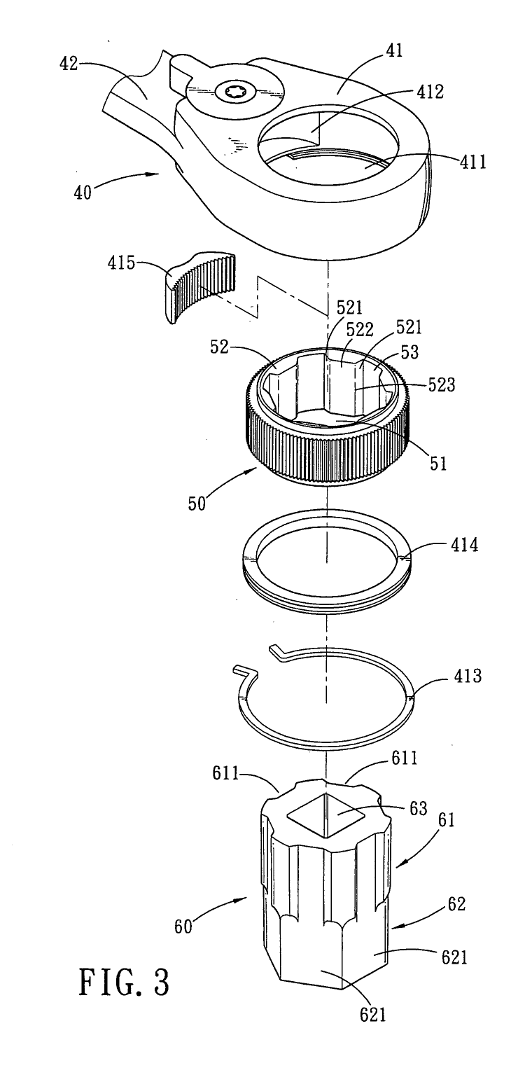

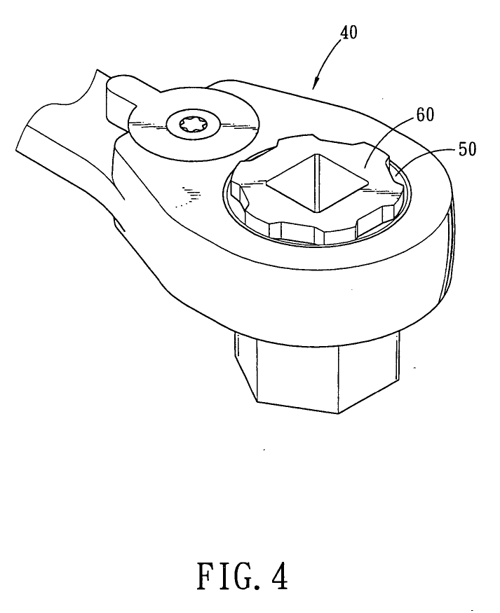

Referring to FIGS. 3-4, a socket and ratchet wrench in accordance with a preferred embodiment of the present invention generally comprises a wrench body 40, an annular-toothed block 50 and a socket 60.

The wrench body 40 has a head portion 41 and a handle portion 42. Adjacent to the center of the head portion 41 is defined a receiving hole 411 and a recess 412 in communication with the receiving hole 411. On the inner periphery of the receiving hole 411 are disposed an elastic C-shaped ring 413 and an O-ring 414, and in the recess 412 is received a locking block 415.

The annular-toothed block 50 is rotatably positioned in the receiving hole 411 of the wrench body 40 by the elastic C-shaped ring 413, the ring 414 and the locking block 415. The annular-toothed block 50 has a through engaging hole 51, on the inner periphery of the engaging hole 51 are defined six ribs 52, and each paired neighboring ribs 52 are connected by a negative arc surface 53. Each of the ribs 52 consists of a flat first engaging surface 521 and two cambered second engaging surfaces 522 each of which is arranged at either side of the first engaging surface 521. The first engaging surface 521 is connected to the second engaging surface 522 via an arc surface 523.

The socket 60 has a first end 61 and a second end 62. The socket 60 is tapered gradually from the first end 61 to the second end 62. On the outer periphery of the first end 61 are defined six grooves 611 for mating with the respective ribs 52 of the annular-toothed block 50. The second end 62 is provided on its outer periphery with six planes 621 for engaging with the second engaging surfaces 522 of the respective ribs 52 of the annular-toothed block 50. Furthermore, the socket 60 is defined with a through engaging hole 63 for engaging with fasteners to be operated.

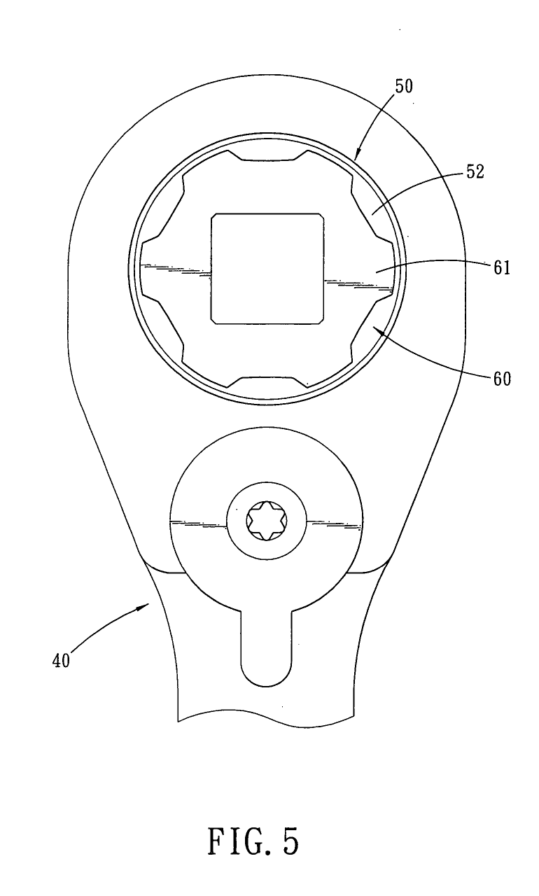

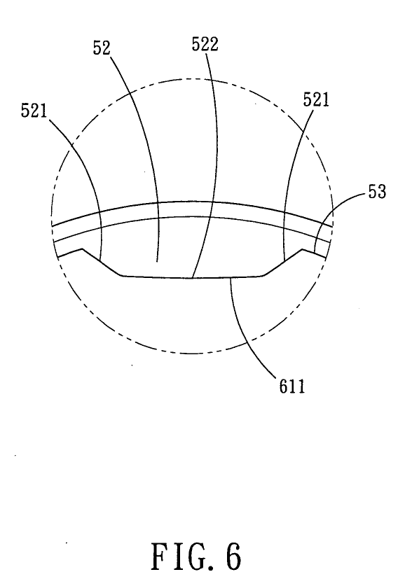

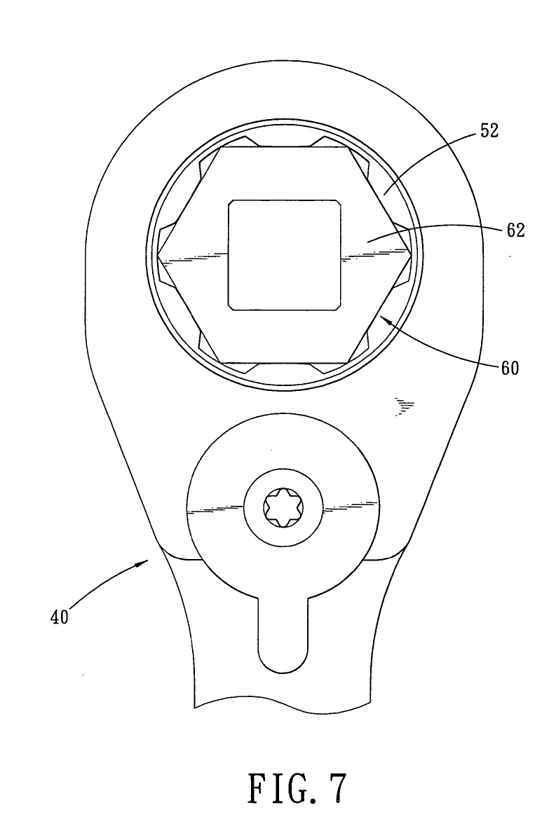

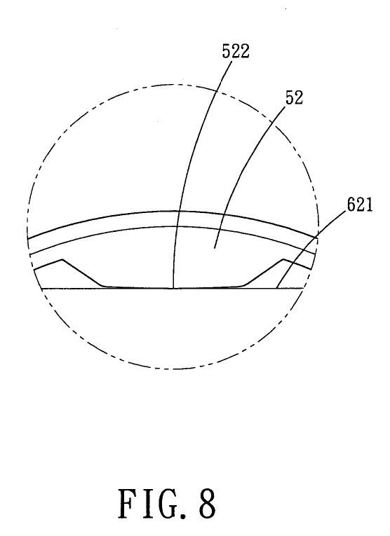

For a better understanding of the present invention, its operation and function, references should be made to FIGS. 5-6, when the wrench body 40 engages with the first end 61 of the socket 60, the first engaging surface 521, the second surface 522 and the negative arc surface 53 of the respective ribs 52 of the annular-toothed block 50 will engage in the respective grooves 611 of the socket 60, and at this moment, ratchet wrench is able to rotate the socket 60. With reference to FIGS. 7-8, the wrench body 40 also can engage with the second end 62 of the socket 60, the second engaging surfaces 62 of the respective ribs 52 of the annular-toothed block 50 are employed to engage with the respective planes 621 of the socket 60, so that the socket 60 can be rotated by the ratchet wrench. Thus, both ends of the socket 60 are suitable for the ratchet wrench of the present invention, in other words, the ratchet wrench of the present invention is capable of engaging with two different shaped sockets.

In addition, since the ratchet wrench can engage with the socket 60 having a hexagonal cross section, it can be used to rotate the fasters having a hexagonal cross section directly without using the socket 60, thus further improving the applicability of the ratchet wrench of the present invention.

While we have shown and described various embodiments in accordance with the present invention, it should be clear to those skilled in the art that further embodiments may be made without departing from the scope of the present invention.

1. A socket and ratchet wrench comprising:
a wrench body having a head portion and a handle portion, and on the head portion defined a receiving hole;
an annular-toothed block rotatably received in the receiving hole of the wrench body, the annular-toothed block having a through engaging hole, on an inner periphery of the engaging hole defined a plurality of ribs each of which connected by a negative arc surface, the respective ribs including a flat first engaging surface and two cambered second engaging surfaces each arranged at either side of the first engaging surface, the first engaging surface connected to the second engaging surface by an arc surface;
a socket having a first end and a second end, on an outer periphery of the first end formed a plurality of grooves for mating with the respective ribs of the annular-toothed block, the second end provided on its outer periphery with multiple planes for engaging with the second engaging surfaces of the respective ribs; and
wherein the socket is tapered gradually from the first end to the second end.
